(19) United States
(12) Patent Application Publication
(10) Pub. No.: US 2026/0257457 A1
(43) Pub. Date: Sep. 3, 2026

(54) VEHICLE WINDOWPANE

(71) Applicant: AGC Inc., Tokyo (JP)

(72) Inventors: Ryusuke WAKABAYASHI, Tokyo (JP); Satoshi KANEKO, Tokyo (JP); Ryuichi SUMIMOTO, Tokyo (JP)

(73) Assignee: AGC Inc., Tokyo (JP)

(21) Appl. No.: 19/653,448

(22) Filed: Apr. 21, 2026

Related U.S. Application Data
(63) Continuation of application No. PCT/JP2024/036081, filed on Oct. 9, 2024.

(30) Foreign Application Priority Data
Oct. 23, 2023 (JP) 2023-181580

(51) Int. Cl. B32B 17/10; B32B 3/04; B32B 3/08; B32B 3/26; B32B 3/30; B60J 1/00

(52) U.S. Cl. CPC B32B 17/10036; B32B 3/04; B32B 3/08; B32B 3/266; B32B 3/30; B32B 17/10385; B32B 17/10513; B32B 2305/345; B32B 2307/202; B32B 2323/16; B32B 2383/00; B32B 2605/00; B60J 1/004

(57) ABSTRACT

A vehicle windowpane includes laminated glass with first and second glass plates and an intermediate film. A thin electric member is disposed between opposing inner main surfaces of the plates. A wire connects to the thin electric member at a first end portion and extends along the inner main surface of the second plate, around its side surface, and onto the outer main surface, where a second end portion is exposed. A resin frame body covers the outer edge of the laminated glass and the wire. A cable is connected to the second end portion of the wire and to a vehicle-body-side wire harness. A holding member on the outer main surface, covered by the frame body, secures the cable.

### CROSS-REFERENCE TO RELATED APPLICATIONS

This application is a continuation application of International Application No. PCT/JP2024/036081 filed Oct. 9, 2024 the disclosure of which is incorporated herein by reference in its entirety. Further, this application claims priorities from Japanese Patent Application No. 2023-181580 filed Oct. 23, 2023, the disclosure of which is incorporated herein by reference in their entirety.

### TECHNICAL FIELD

The present disclosure relates to a vehicle windowpane.

### BACKGROUND ART

Conventionally, there is a plate-shaped body with a resin frame body that has a decorative molding at a resin frame body of the plate-shaped body with a resin frame body. This decorative molding has a main body portion and a film attached to the surface of the main body portion, and has a design portion exposed at the surface of the resin frame body and an embedded portion that is embedded in the resin frame body. The film is attached so as to cover the design portion and the embedded portion continuously (refer to Japanese Patent Application Laid-Open (JP-A) No. 2019-209614 (Patent Document 1) for example).

By the way, in a conventional plate-shaped body with a resin frame body, the frame body that is made of resin is attached to a single glass plate that serves as the plate-shaped body, and, for example, electric members are not provided between two glass plates of a laminated glass. In a case in which an electric member is provided between the two glass plates of a laminated glass, cables that transmit electric power and control signals and the like are needed, and therefore, there is the concern that the frame body and structures at the periphery thereof will become complex.

### SUMMARY

Thus, an object of an aspect of the present disclosure is to provide a vehicle windowpane that has a simple structure and includes a frame body covering the outer edge of a laminated glass in which a thin electric member is provided between two glass plates.

### Solution to Problem

A vehicle windowpane of an aspect of the present disclosure includes: a laminated glass provided at an opening portion of a vehicle body and having a first glass plate that has a first main surface, a second main surface and a first side surface, a second glass plate that has a third main surface, a fourth main surface and a second side surface, and an intermediate film provided between the second main surface and the third main surface; a thin electric member provided between the second main surface and the third main surface; a wire that, between a first end portion of the wire, which first end portion is connected to the thin electric member between the second main surface and the third main surface, and a second end portion of the wire, which second end portion is provided at the fourth main surface, extends along the third main surface, the second side surface and the fourth main surface; a frame body made of resin and covering an outer edge of the laminated glass as seen in a plan view, and the wire; a cable having one end connected to the second end portion of the wire, and another end connected to a wire harness that is at the vehicle body side; and a holding member provided at the fourth main surface, and covered by the frame body, and holding the cable.

In accordance with the present disclosure, there is provided a vehicle windowpane that has a simple structure and includes a frame body covering the outer edge of a laminated glass in which a thin electric member is provided between two glass plates.

### BRIEF DESCRIPTION OF DRAWINGS

FIG. 1 is a drawing illustrating an example of the structure of a vehicle windowpane 100 of an embodiment.

FIG. 2A is a drawing illustrating an example of the cross-sectional structure of the vehicle windowpane 100, and is a drawing illustrating the cross-section viewed in the direction of arrows A-A of FIG. 1.

FIG. 2B is a drawing illustrating, in an XZ plane, the structure viewed in the direction of arrow B of FIG. 2A.

FIG. 2C is a drawing illustrating an example of the structure of a holding member 150.

FIG. 3A is a drawing illustrating an example of the structure of a holding member 150M1 of a first modified example of the embodiment.

FIG. 3B is a drawing illustrating an example of the structure of a vehicle windowpane 100M2 of a second modified example of the embodiment.

FIG. 3C is a drawing illustrating an example of the cross-sectional structure of a vehicle windowpane 100M3 of a third modified example of the embodiment.

### DETAILED DESCRIPTION

An embodiment that implements the vehicle windowpane of the present disclosure is described hereinafter. Hereinafter, the same elements are denoted by the same reference numerals, and there are cases in which redundant description is omitted.

Hereinafter, there are cases in which the lengths, sizes, thicknesses and the like of respective portions are illustrated in an exaggerated manner in order to make the structures easy to understand. Further, expressions such as parallel, right angle, perpendicular, horizontal, orthogonal, vertical and the like are expressions that permit offset to the extent of not deteriorating the effects of the embodiment.

### Embodiment

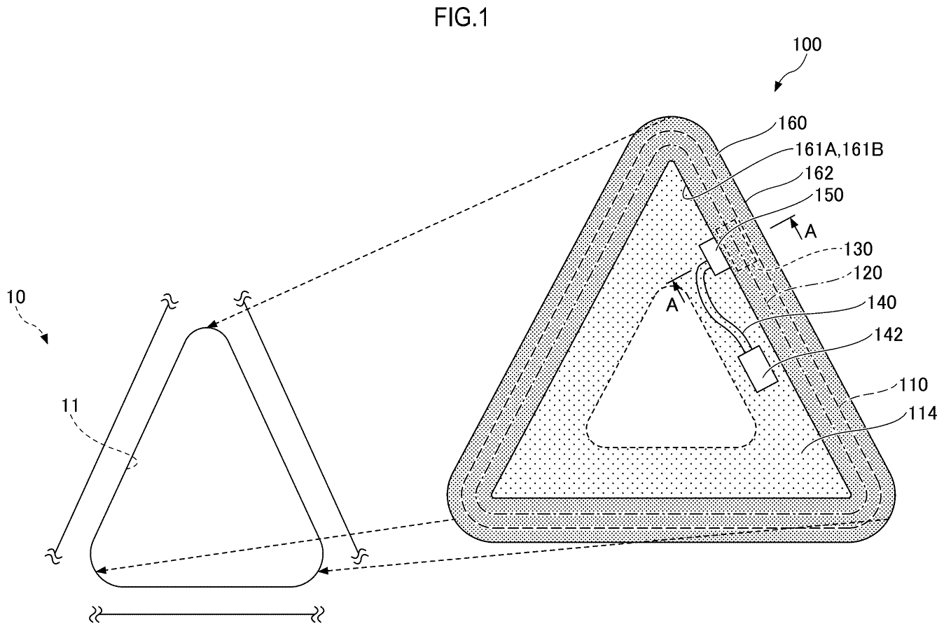

FIG. 1 is a drawing illustrating an example of the structure of a vehicle windowpane 100 of an embodiment. FIG. 1 illustrates an example of a state in which the vehicle windowpane 100 is viewed from a cabin inner side toward a cabin outer side of a vehicle body 10. In FIG. 1, the vehicle windowpane 100 is illustrated as being flat-plate-shaped, but the vehicle windowpane 100 may be curved in an arbitrary one direction or two or more directions.

The vehicle windowpane 100 is mounted to an opening portion 11 of the vehicle body 10. In FIG. 1, the portion of the vehicle body 10 at the periphery of the opening portion 11 of the vehicle body 10 is illustrated. Further, in FIG. 1, the vehicle windowpane 100 is illustrated as being larger than the opening portion 11 for easier understanding.

The opening portion 11 is a window frame for attachment of the vehicle windowpane 100, and a flange is provided thereat. As an example, the vehicle windowpane 100 is mounted to the opening portion 11 from the cabin outer side, but may be mounted from the cabin inner side.

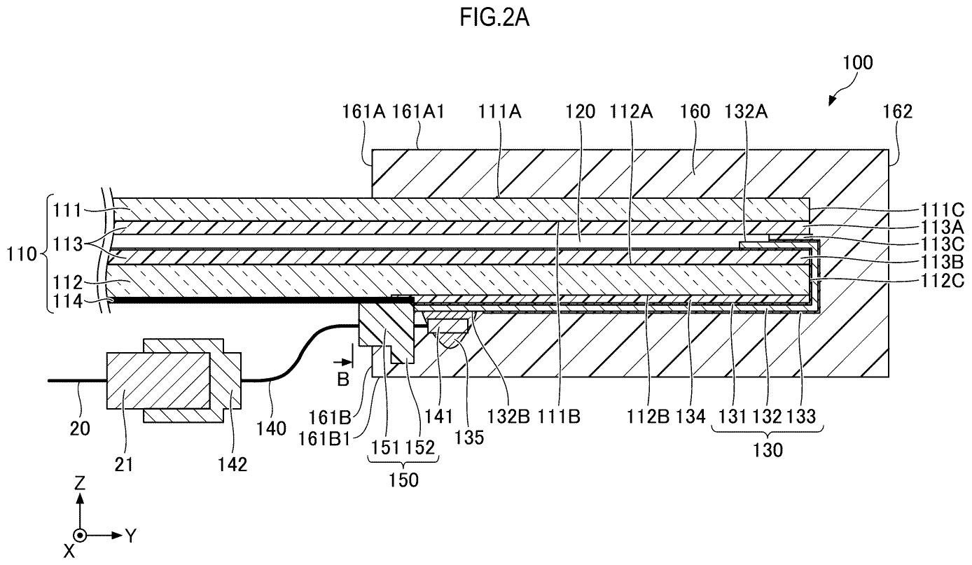

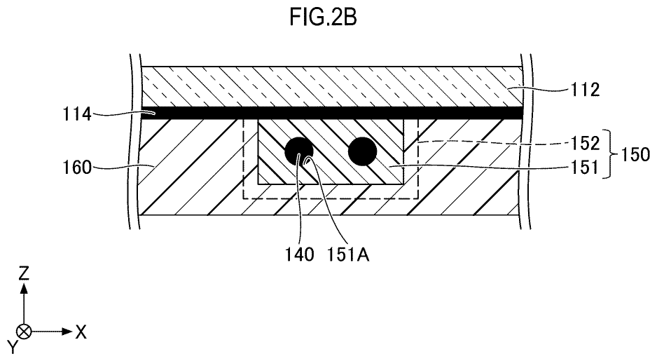

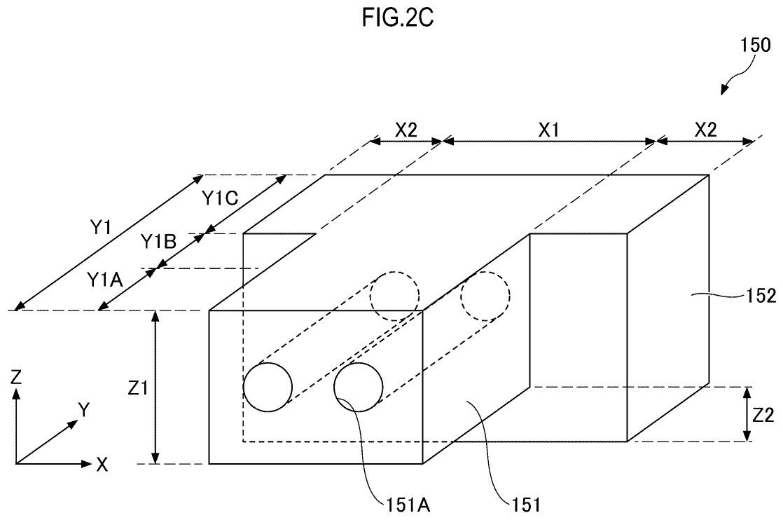

Further, in FIG. 1, the planar shape of a laminated glass 110 is roughly triangular, but the planar shape of the laminated glass 110 is not limited to triangular, and, for example, may be quadrangular such as rectangular or trapezoidal, or may be another arbitrary shape. The planar shape here means the shape when a predetermined region of the laminated glass 110 is viewed from the normal line direction of a fourth main surface 112B (refer to FIG. 2A) that is at the cabin inner side of the laminated glass 110.

The vehicle windowpane 100 can be applied to, for example, a roof windowpane, a rear windshield, a side windowpane, a quarter windowpane, an extra windowpane or the front windshield of a vehicle. Note that an extra windowpane is a windowpane that is mounted lower than the rear windshield of a vehicle in order to improve the rearward visibility of the driver of the vehicle. The vehicle here is an automobile such as, for example, an EV (Electric Vehicle), a PHEV (Plug-in Hybrid Electric Vehicle), an HV (Hybrid Vehicle), a gasoline-powered vehicle or a diesel-powered vehicle. Further, the vehicle may be a streetcar or a train.

Further, although a form in which the vehicle windowpane 100 is fixed to the opening portion 11 is described here, the laminated glass 110 may be provided so as to be slidable with respect to the vehicle body 10. For example, in a case in which the laminated glass 110 is used as a roof windowpane or a side windowpane, the laminated glass 110 may be structured so as to be freely opened and closed with respect to the opening portion 11 by a driving mechanism such as a motor and a regulator that is provided at the vehicle body 10 side.

The vehicle windowpane 100 is a Module Assembly Window® (MAW) that includes the laminated glass 110 and a frame body 160 provided along the outer edge of the laminated glass 110. In the state in which the frame body 160 is attached to the laminated glass 110, the vehicle windowpane 100 can be mounted as is to the opening portion 11 of the vehicle body 10, and therefore, the vehicle assembly work can be simplified.

### Vehicle Windowpane 100

The vehicle windowpane 100 includes the laminated glass 110, a light adjusting panel 120, an FPC (Flexible Printed Circuit) 130, a cable 140, a holding member 150 and the frame body 160. The light adjusting panel 120 is an example of the thin electric member. The FPC 130 is an example of the flexible substrate.

Here, as an example, description is given of a form in which the example of the thin electric member is the light adjusting panel 120, but the thin electric member is not limited to the light adjusting panel 120. It suffices for the thin electric member to be a functional film, or an electric heating wire or an electrically conductive film or the like for heating, and the light adjusting panel 120 is an example of a functional film. Thin electric members other than the light adjusting panel 120 are described later.

Description is given hereinafter by using FIG. 2A and FIG. 2B in addition to FIG. 1. Description is given by defining an XYZ coordinate in FIG. 2A and FIG. 2B. The direction parallel to the X-axis (the X direction), the direction parallel to the Y-axis (the Y direction) and the direction parallel to the Z-axis (the Z direction) are perpendicular to one another. The +Z direction side is the cabin outer side of the vehicle body 10. The Z-axis extends in the normal line direction of the laminated glass 110. Hereinafter, as seen in a plan view means viewing an object in the XY plane in the direction in which the Z-axis extends.

FIG. 2A is a drawing illustrating an example of the cross-sectional structure of the vehicle windowpane 100, and is a drawing illustrating the cross-section viewed in the direction of arrows A-A of FIG. 1. FIG. 2B is a drawing illustrating, in the XZ plane, the structure viewed in the direction of arrow B at the position of arrow B in FIG. 2A. Note that a wire harness 20 and a connector 21, which are at the vehicle body 10 side and whose illustration is omitted in FIG. 1, are illustrated in FIG. 2A.

Note that, although interior panels and the like that are at the cabin inner side of the vehicle body 10 are omitted in FIG. 1 and FIG. 2A, the FPC 130, the cable 140, the holding member 150, the frame body 160, the wire harness 20 and the connector 21 are covered by an interior panel and the like that are at the cabin inner side of the vehicle body 10, and therefore, are not seen from the cabin inner side.

### Laminated Glass 110

The laminated glass 110 has a first glass plate 111, a second glass plate 112, an intermediate film 113 and a shielding layer 114. The laminated glass 110 is formed by the first glass plate 111, which is provided at the cabin outer side of the vehicle body 10, and the second glass plate 112, which is provided at the cabin inner side of the vehicle body 10, being adhered together via the intermediate film 113 that is disposed between the first glass plate 111 and the second glass plate 112. Further, the light adjusting panel 120 and the FPC 130 are provided at portions of the region between the first glass plate 111 and the second glass plate 112.

The total thickness of the laminated glass 110 is preferably 2.8 mm or more and 10 mm or less. The total thickness of the laminated glass 110 is the thickness of the laminated glass 110 between a first main surface 111A at the cabin outer side of the first glass plate 111 and the fourth main surface 112B at the cabin inner side of the second glass plate 112. If the total thickness of the laminated glass 110 is 2.8 mm or more, sufficient rigidity can be ensured. Further, if the total thickness of the laminated glass 110 is 10 mm or less, sufficient transmittivity can be ensured, and the mass does not become excessively large. Note that the total thickness here, and the thicknesses that will be described hereinafter, mean the lengths in the Z direction.

### First Glass Plate 111 and Second Glass Plate 112

The first glass plate 111 and the second glass plate 112 are transparent, plate-shaped glass plates. The first glass plate 111 has the first main surface 111A at the cabin outer side, a second main surface 111B at the cabin inner side, and a first side surface 111C. The first side surface 111C is the end surface that connects the first main surface 111A and the second main surface 111B. The second glass plate 112 has a third main surface 112A at the cabin outer side, the fourth main surface 112B at the cabin inner side, and a second side surface 112C. The second side surface 112C is the end surface that connects the third main surface 112A and the fourth main surface 112B. Note that the first glass plate 111 and the second glass plate 112 may be flat-plate shapes, or may be curved shapes that are curved in an arbitrary one direction or two or more directions.

The first glass plate 111 and the second glass plate 112 may be inorganic glass or may be organic glass. For example, soda-lime glass, aluminosilicate glass, borosilicate glass, alkali-free glass and quartz glass are used as the inorganic glass without any particular limitations. From the standpoint of scratch resistance, the first glass plate 111 is preferably an inorganic glass. Further, from the standpoints of manufacturing cost and moldability, the first glass plate 111 and the second glass plate 112 are particularly preferably soda-lime glass. In a case in which the first glass plate 111 and the second glass plate 112 are soda-lime glass, they can be used as clear glasses, green glasses or UV cutting green glasses that contain a predetermined amount or more of an iron component, privacy glasses, or the like.

In a case in which the first glass plate 111 and the second glass plate 112 are inorganic glass, the first glass plate 111 and the second glass plate 112 may be either of non-tempered glass or tempered glass. Non-tempered glass is formed by molding molten glass into a plate shape and carrying out gradual cooling. Tempered glass is glass in which a compressive stress layer is formed on the surface of a non-tempered glass, and may be either of air-cooled tempered glass or chemically tempered glass.

In a case in which the first glass plate 111 and the second glass plate 112 are physically tempered glass (e.g., air-cooled tempered glass), the glass surface may be tempered by, in the bending molding, a compressive stress layer being formed on the glass surface due to the temperature difference between the glass surface and the glass interior by an operation other than gradual cooling such as rapid cooling, from a temperature near the melting point, a glass plate that has been heated uniformly. In a case in which the tempered glass is a chemically tempered glass, the glass surface may be tempered by, after the bending molding, generating compressive stress at the glass surface by an ion exchange method or the like. Further, glass plates that absorb ultraviolet light or infrared light may be used as the first glass plate 111 and the second glass plate 112. The first glass plate 111 and the second glass plate 112 are preferably transparent, but may be glass plates that are colored to the extent of not deteriorating the transparency.

On the other hand, examples of organic glass materials are acrylic resins such as polycarbonate and polymethyl methacrylate, and transparent resins such as polyvinyl chloride and polystyrene.

The laminated glass 110 may be a curved shape that is such that the cabin outer side thereof is convex when the laminated glass 110 is mounted to the vehicle body 10. The laminated glass 110 may have a curved shape of a single curve that is bendingly molded in only one direction, or may have a curved shape with plural curves that is bendingly molded in two directions. These two directions are, for example, the vertical direction and the left-right direction that is perpendicular to the vertical direction, when the laminated glass 110 is mounted to the vehicle body 10. Gravity molding, press molding, roller molding or the like is used for the bending molding of the laminated glass 110. In a case in which the laminated glass 110 is bendingly molded to a predetermined curvature, the radius of curvature of the laminated glass 110 may be 1000 mm or more and 100,000 mm or less.

Further, when the laminated glass 110 is mounted to the vehicle body 10, the thickness of the first glass plate 111 that is positioned at the cabin outer side and the thickness of the second glass plate 112 that is positioned at the cabin inner side may be the same or may be different. The thickness of the first glass plate 111 is preferably 1.0 mm or more and 3.6 mm or less. If the thickness of the first glass plate 111 is 1.0 mm or more, strength such as the resistance with respect to flung-up stones is sufficient. The thickness being 3.6 mm or less is preferable from the standpoints of the mass of the laminated glass 110 not becoming excessively large and the fuel efficiency of the vehicle. The thickness of the second glass plate 112 is preferably 0.3 mm or more and 2.7 mm or less. If the thickness of the second glass plate 112 is 0.3 mm or more, the ability to handle the second glass plate 112 is good. If the thickness is 2.7 mm or less, the mass of the laminated glass 110 does not become excessively large. If the thickness of each of the first glass plate 111 and the second glass plate 112 is 1.8 mm or less, both lightening of the weight of and the sound insulating ability of the laminated glass 110 can be achieved, which is preferable. Note that, if the thickness of the second glass plate 112 is 1.0 mm or less, the second glass plate 112 may be a chemically tempered glass. If the second glass plate 112 is a chemically tempered glass, it is preferable that the compressive stress value of the glass surface be 300 MPa or more and that the depth of the compressive stress layer be 2 μm or more. Note that thickness here is preferably the thickness of the thinnest portion of the first glass plate 111 and the second glass plate 112.

The first glass plate 111 preferably has impact resistance that is suitable for use in a vehicle. Note that impact resistance here can be evaluated by using the impact resistance test of UN R43 for example. An impact resistance test is a test in which, for example, it is investigated whether or not a safety glass such as a laminated glass for an automobile has the tackiness or the strength needed with respect to impact from small, hard flying objects. Specifically, this test is carried out by, after maintaining a laminated glass (safety glass) at a predetermined temperature, placing the laminated glass at a supporting frame with the first main surface 111A of the first glass plate 111 facing upward, and freely dropping a steel ball thereon from a predetermined height.

Further, a film that has the functions of repelling water and cutting ultraviolet light and infrared light, a film that has a low reflection characteristic, a low radiation characteristic, and a stainproofing characteristic, and/or a film that has a condensation proofing characteristic may be provided on at least one of the first main surface 111A of the first glass plate 111 and the fourth main surface 112B of the second glass plate 112. Further, a film that cuts ultraviolet light and infrared light, or that has a low radiation characteristic, or that absorbs visible light, or that is for coloring may be provided on at least one of the second main surface 111B of the first glass plate 111 and the third main surface 112A of the second glass plate 112. Further, a low radiation coating may be formed on the fourth main surface 112B of the second glass plate 112.

Namely, at least one of the first glass plate 111 and the second glass plate 112 may have any one or more of a water repelling layer, an ultraviolet ray cutting layer, an infrared ray reflecting layer, a low reflectance layer, a low emissivity layer, a condensation proofing layer, a visible light absorbing layer, and a coloring layer.

### Intermediate Film 113

The intermediate film 113 is provided between the first glass plate 111 and the second glass plate 112. It is preferable that the intermediate film 113 surrounds the side surface of the light adjusting panel 120. The side surface of the light adjusting panel 120 is the end surface that connects the surface at the +Z direction side and the surface at the −Z direction side of the light adjusting panel 120. Note that first end portions 132A of wires 132 of the FPC 130 are connected to the +Y direction side end portion of the light adjusting panel 120. Therefore, the intermediate film 113 surrounds, in addition to the side surface of the light adjusting panel 120, the joined portion of the light adjusting panel 120 and the first end portions 132A, and, of the FPC 130, the portion thereof that is positioned between the first glass plate 111 and the second glass plate 112.

The intermediate film 113 has a first intermediate film 113A joined to the first glass plate 111, a second intermediate film 113B joined to the second glass plate 112, and a third intermediate film 113C that is frame shaped, is positioned between the first intermediate film 113A and the second intermediate film 113B, and surrounds the side surface of the light adjusting panel 120. In this example, the third intermediate film 113C surrounds the side surface of the light adjusting panel 120, but the third intermediate film 113C does not have to be provided. Even in a case in which the third intermediate film 113C is not provided, provided that the side surface of the light adjusting panel 120 is positioned further toward the inner side as seen in a plan view than the first side surface 111C of the first glass plate 111 or the second side surface 112C of the second glass plate 112, the side surface of the light adjusting panel 120 is surrounded due to at least one of the first intermediate film 113A and the second intermediate film 113B deforming at the time of crimping in the process of manufacturing the laminated glass 110. If the thickness of the light adjusting panel 120 is large, the difference between the thicknesses of the portion where the light adjusting panel 120 exists and the portion further toward the outer side than the light adjusting panel 120 as seen in a plan view is large, and therefore, it is preferable to provide the third intermediate film 113C in order to fill-in the difference in thicknesses.

Note that, as an example, a structure is described in which the first intermediate film 113A, the second intermediate film 113B and the third intermediate film 113C are separate bodies, and are joined at the time of manufacturing the laminated glass 110. However, the present disclosure is not limited to such a structure, and the intermediate film 113 may be integral in a case in which, for example, the intermediate film 113 is formed by causing a material having high fluidity to flow in between the first glass plate 111 and the second glass plate 112.

Thermoplastic resins are often used as the intermediate film 113, and examples are thermoplastic resins that are used in various conventional applications such as plasticized polyvinyl acetal resins, plasticized polyvinyl chloride resins, saturated polyester resins, plasticized saturated polyester resins, polyurethane resins, plasticized polyurethane resins, ethylene-vinyl acetate copolymer resins, ethylene-ethyl acrylate copolymer resins, cycloolefin polymer resins, and ionomer resins. Further, the resin compositions having modified block copolymer hydrides that are described in U.S. Pat. No. 6,065,221 also can be suitably used.

Thereamong, plasticized polyvinyl acetal resins are preferably used as the material of the intermediate film 113 from the standpoint of having an excellent balance of various performances such as transparency, weather resistance, strength, adhesive strength, penetration resistance, impact energy absorbing ability, moisture resistance, heat shielding ability, and sound insulating ability. A single one of these thermoplastic resins may be used, or two or more types may be used together. The “plasticized” in the aforementioned plasticized vinyl acetal resins means having been plasticized by the addition of a plasticizer. The same holds for plasticized resins other than these.

However, in a case in which the light adjusting panel 120 is sealed by the intermediate film 113, there are cases in which, depending on the type of the object that is sealed, that sealed object deteriorates due to specific plasticizers. In this case, it is preferable to use a resin that substantially does not contain such a plasticizer. Namely, there are cases in which it is preferable for the intermediate film 113 to not contain a plasticizer. Examples of resins that do not contain a plasticizer are ethylene-vinyl acetate copolymer resins.

Examples of the aforementioned polyvinyl acetal resins are polyvinyl formal resins obtained by reacting polyvinyl alcohol (hereinafter also called PVA upon occasion) and formaldehyde, polyvinyl acetal resins in the narrow sense obtained by reacting PVA and acetaldehyde, and polyvinyl butyral resins (hereinafter also called PVB upon occasion) obtained by reacting PVA and n-butyraldehyde. In particular, PVB is exemplified as a suitable resin because it has an excellent balance of various performances such as transparency, weather resistance, strength, adhesive strength, penetration resistance, impact energy absorbing ability, moisture resistance, heat shielding ability, and sound insulating ability. Note that a single one of these polyvinyl acetal resins may be used, or two or more types may be used together.

A curable transparent resin also called Optical Clear Resin (OCR) and a transparent adhesive sheet also called Optical Clear Adhesive (OCA) may be used as the intermediate film 113. By using a curable transparent resin or a transparent adhesive sheet, it is possible to fabricate the layered body (laminated glass) at usual temperatures, which is more desirable. Resins that are acrylic, silicone, urethane acrylate, and epoxy for example are used as the curable transparent resin or the transparent adhesive sheet. Note that a single one of these curable transparent resins or transparent adhesive sheets may be used, or two or more types may be used together.

The material of which the intermediate film 113 is formed is not limited to a thermoplastic resin. Further, the intermediate film 113 may contain functional particles of an infrared ray absorber, an ultraviolet ray absorber, a luminescent agent, or the like. Moreover, the intermediate film 113 may have a colored portion that is called a shade band.

The thickness of the intermediate film 113 is preferably 0.3 mm or more at the thinnest portion thereof. If the thickness of the thinnest portion of the intermediate film 113 is 0.3 mm or more, the impact resistance needed for the laminated glass 110 is sufficient. The thickness of the intermediate film 113 is preferably 3 mm or less at the thickest portion thereof. If the maximum value of the thickness of the intermediate film 113 is 3 mm or less, the mass of the laminated glass 110 does not become excessively large. The maximum value of the thickness of the intermediate film 113 is more preferably 2.8 mm or less, and even more preferably 2.6 mm or less.

Note that the thickness of the intermediate film 113 means the thickness of only the intermediate film 113, excluding the thickness of the light adjusting panel 120. Therefore, the thickness of the intermediate film 113 means the length obtained by subtracting the thickness of the light adjusting panel 120 from the thickness that is from the boundary (the second main surface 111B) of the first intermediate film 113A with the first glass plate 111 to the boundary (the third main surface 112A) of the second intermediate film 113B with the second glass plate 112.

Further, the thickest portion of the intermediate film 113 is, for example, the portion that does not nip-in the light adjusting panel 120 (the portion that does not overlap the light adjusting panel 120 as seen in a plan view). The thinnest portion of the intermediate film 113 is, for example, the portion that nips-in the light adjusting panel 120 (the portion overlapping the light adjusting panel 120 as seen in a plan view).

Further, it is desirable that the first intermediate film 113A, the second intermediate film 113B and the third intermediate film 113C that are included in the intermediate film 113 all be formed of the same material. However, some of or all of the first intermediate film 113A, the second intermediate film 113B and the third intermediate film 113C may be formed of different materials. For example, the first intermediate film 113A and the second intermediate film 113B may be formed of the same material, and the third intermediate film 113C may be formed of another material.

In fabricating the intermediate film 113, for example, the above-described resin material that is to become the intermediate layer is selected appropriately, and extrusion molding is carried out in a heated and molten state by an extruder. The extrusion conditions such as the extrusion speed of the extruder are set so as to be uniform. Thereafter, the intermediate film 113 is completed by, for example, carrying out drawing as needed in order to provide the resin film, that has been fabricated by the extrusion molding, with curvature in accordance with the design of the laminated glass 110.

### Shielding Layer 114

The shielding layer 114 is an opaque layer. The shielding layer 114 is, for example, an opaque, colored (e.g., black) ceramic layer. The shielding layer 114 may be a colored intermediate film or a colored film that is light-shielding, or a combination of a colored intermediate film and a colored ceramic layer. A colored film may be formed integrally with an infrared light reflecting film or the like. Here, opaque means a visible light transmittivity of 5% or less, and preferably 3% or less, and more preferably 1% or less, and substantially 0% also is included. The shielding layer 114 suppresses deterioration, due to ultraviolet light, of the resin such as urethane that holds the laminated glass 110 with respect to the vehicle body 10.

For example, the shielding layer 114 can be formed by coating a ceramic color paste, which contains fusible glass frit containing a black pigment, onto a glass plate by screen printing or the like, and carrying out baking, but the method of forming the shielding layer 114 is not limited to this. For example, the shielding layer 114 may be formed by coating an organic ink, which contains a black or dark pigment, onto a glass plate by screen printing or the like, and carrying out drying.

As an example, the shielding layer 114 is provided in the shape of a strip along the outer edge of the laminated glass 110. Specifically, as illustrated in FIG. 1, as seen in a plan view, the shielding layer 114 is provided in the shape of a strip at the inner side of the frame body 160 that covers the outer edge of the laminated glass 110. In FIG. 1, the frame body 160 is shown by the dense dots, and the portion of the shielding layer 114 that is further toward the inner side than the inner edge of the frame body 160 is shown by the sparse dots. The portion of the shielding layer 114 that is shown by the sparse dots is the portion that can be seen from the cabin outer side in the state in which the vehicle windowpane 100 is mounted to the opening portion 11. As an example, because the laminated glass 110 is triangular as seen in a plan view, the frame body 160 is triangular annular as seen in a plan view, and the shielding layer 114 also is triangular annular.

As illustrated in FIG. 2A, as an example, the shielding layer 114 is formed at the fourth main surface 112B of the second glass plate 112 so as to span over inner edges 161A and 161B of the frame body 160 as seen in a plan view. Namely, the shielding layer 114 has a portion that overlaps the frame body 160 as seen in a plan view, and a portion that is positioned further toward the inner side than the inner edges 161A and 161B of the frame body 160 and does not overlap the frame body 160 as seen in a plan view. Further, the shielding layer 114 partially overlaps the light adjusting panel 120 as seen in a plan view.

It suffices for the width of the shielding layer 114 to be a width of an extent such that it can hide the wire harness 20, the connector 21, connectors 142, the cables 140, and the holding member 150. The width of the shielding layer 114 is the width in the Y direction in FIG. 2A, and is the width of the strip-shaped portion of the triangular annulus in FIG. 1. In other words, the width of the shielding layer 114 is the width in the direction orthogonal to the inner edge of the shielding layer 114 that is triangular annular as seen in a plan view.

Note that the shielding layer 114 is not limited to a structure that is formed at the fourth main surface 112B, and may be formed at the second main surface 111B of the first glass plate 111 or at the third main surface 112A of the second glass plate 112. The shielding layer 114 may be formed at a combination of the second main surface 111B and the fourth main surface 112B, or the second main surface 111B and the third main surface 112A, or the third main surface 112A and the fourth main surface 112B. Further, the shielding layer 114 may be provided at the surface of the first intermediate film 113A or the second intermediate film 113B, or may be embedded within the first intermediate film 113A or the second intermediate film 113B.

### Light Adjusting Panel 120

The light adjusting panel 120 is an example of the thin electric member and the functional film. Thin means having a thickness that is thin to the extent of being able to be placed between the two plates that are the first glass plate 111 and the second glass plate 112 of the laminated glass 110.

As illustrated in FIG. 1, as an example, the light adjusting panel 120 is triangular as seen in a plan view, and is disposed so as fall within the inner sides of the three sides of the outer edge of the laminated glass 110 that is triangular as seen in a plan view. Here, description is given of a form in which the light adjusting panel 120 is triangular as seen in a plan view, but the shape of the light adjusting panel 120 as seen in a plan view is not limited to triangular. The light adjusting panel 120 may be rectangular or an arbitrary shape, so as to accord with the shape of the laminated glass 110 as seen in a plan view. Further, the light adjusting panel 120 may be an arbitrary shape that falls within the outer edge of the laminated glass 110, without according with the shape of the laminated glass 110 as seen in a plan view.

As an example, the light adjusting panel 120 is a member whose transmittivity changes depending on the electric power supplied via the FPC 130. Here, as an example, description is given of a form in which the transmittivity of the light adjusting panel 120 changes between two levels that are a high state and a low state, in accordance with the absence/presence of electric power supplied via the two wires 132 of the FPC 130. When electric power is supplied via the wires 132 of the FPC 130, the light adjusting panel 120 is turned on and enters into a state in which the transmittivity thereof is high. When the supply of electric power is cut-off, the light adjusting panel 120 is turned off and enters into a state in which the transmittivity thereof is low. The switching between supplying of electric power via the two wires 132 and not supplying electric power bears the function of a control signal that switches the light adjusting panel 120 on and off.

However, the light adjusting panel 120 may be a panel whose transmittivity changes in accordance with the duty ratio of a PWM (Pulse Width Modulation) pulse signal. As an example, the light adjusting panel 120 may be a structure in which a light adjusting device, whose transmittivity changes in accordance with the duty ratio of a PWM pulse signal, is affixed to a panel made of resin or made of glass. A suspended particle device (SPD), a polymer dispersed liquid crystal (PDLC) device, a polymer network liquid crystal (PNLC) device, a guest/host liquid crystal device, a photochromic device, an electrochromic device, an electrokinetic device or the like can also be used as the light adjusting device.

In a case in which the transmittivity is varied in two levels, the light adjusting panel 120 is transparent in the state in which the transmittivity is high, and, in the state in which the transmittivity is low, the light adjusting panel 120 changes to an opaque state such as grey and enters into a state in which it substantially does not transmit light therethrough. Further, in a case in which the light adjusting panel 120 is driven by a PWM pulse signal, the transmittivity can be controlled in plural stages between a transparent state and an opaque state. As an example, the transmittivity of the light adjusting panel 120 becomes a minimum in a state in which the duty ratio of the PWM pulse signal is 0%.

The light adjusting panel 120 is provided at, of the entire region of the laminated glass 110 as seen in a plan view, the region that closes the opening portion 11. This is because the light adjusting panel 120 is disposed at a position at which it can be seen from the cabin outer side and the cabin inner side of the vehicle body 10. Note that, in a case in which the laminated glass 110 is provided so as to be slidable with respect to the vehicle body 10, it suffices to provide the light adjusting panel 120 at, of the entire region of the laminated glass 110, the region that closes the opening portion in the state in which the laminated glass 110 is completely closed with respect to the vehicle body 10. This is because the light adjusting panel 120 is disposed at a position at which it can be seen from the cabin outer side and the cabin inner side of the vehicle body 10 in the state in which the laminated glass 110 is completely closed with respect to the vehicle body 10.

Further, as described above, the thin electric member is not limited to the light adjusting panel 120, and may be a functional film other than the light adjusting panel 120, or may be an electric heating wire, an electrically conductive film or the like for heating.

A functional film is a member that imparts an additional function to the laminated glass 110. Examples of functional films other than the light adjusting panel 120 are light emitting display films and solar battery films. A light emitting display film is a film-like display device in which pixels structured by light emitting elements are arrayed, and can display images due to electricity being supplied to the light emitting elements of the respective pixels. The light emitting elements include organic EL (electroluminescence) elements and inorganic EL elements. A solar battery film is a structure in which photoelectric converting elements that convert light energy into electric power are formed on a film.

Examples of an electric heating wire for heating are an electric heating wire that functions as a defogger for removing fog (water drops) sticking to the surface of the vehicle windowpane 100, and an electric heating wire that functions as a deicer that effectively melts ice or snow sticking to the outer surface of the vehicle windowpane 100. These electric heating wires are structured by tungsten wires for example. The pitch between the heating wires in the X direction is around 2 mm as an example. In a case in which the electric heating wire functions as a deicer, the current value that flows to the electric heating wire may be set to be higher (e.g., around two times) that that of a case in which the electric heating wire functions as a defogger. Therefore, the electric heating wire that functions as a deicer is thick as compared with an electric heating wire that functions as a defogger. An electric heating wire that functions as a defogger is, as an example, plural electric heating wires that extend in a horizontal direction, and that are arrayed at a uniform pitch as an example. Further, the electric heating wire that functions as a deicer is, as an example, plural electric heating wires that extend in a heightwise direction (vertical direction) that is orthogonal to the horizontal direction, and that are arrayed at a uniform pitch as an example.

Further, a transparent electrically conductive film that functions as a defogger or a deicer is an example of an electrically conductive film for heating. Such a transparent electrically conductive film can be used instead of the above-described electric heating wire. Examples of transparent electrically conductive films are metal films such as an Ag film, metal oxide films such as an ITO (indium tin oxide) film, and resin films containing electrically conductive fine particles. The transparent electrically conductive film may be formed by layering plural types of films.

Further, in a case in which an electric heating wire for heating or an electrically conductive film for heating is provided as the thin electric member between the first glass plate 111 and the second glass plate 112, an anti-fogging film may be provided at the fourth main surface 112B of the second glass plate 112. An anti-fogging film is a film that, as an example, contains a water absorbing polymer or a hydrophilic polymer and that realizes a strong water absorbing ability.

The vehicle windowpane 100 that contains any of various types of thin electric members can be provided due to the thin electric member being a functional film, an electric heating wire for heating or an electrically conductive film for heating. Further, at the vehicle windowpane 100 that contains any of various types of thin electric members, simplification of the structure can be devised by the structures of the holding member 150 and the frame body 160 that are described hereafter.

### FPC 130

The FPC 130 is provided in order to transmit electric power and control signals and the like to the thin electric member. Here, a form in which the vehicle windowpane 100 includes the FPC 130 is described, but, instead of the FPC 130, a cable at which an insulative coating is provided on a wire (an electrically conductive wire) may be used.

As an example, as illustrated in FIG. 1, the FPC 130 is provided at a portion of one side of the three sides of the outer edges of the laminated glass 110 and the light adjusting panel 120 that are triangular as seen in a plan view.

As illustrated in FIG. 2, the FPC 130 has a substrate 131, the wires 132, and a cover lay 133. Two of the wires 132 are formed at one surface of the substrate 131 and are covered by the cover lay 133. The substrate 131 and the cover lay 133 are fixed to one another by being laminated or by being adhered by an adhesive in a state of nipping the wires 132 therebetween.

The substrate 131 and the cover lay 133 are structured by flexible resin films such as polyimide as an example. The wires 132 are wires formed by patterning copper foil as an example.

Each of the wires 132 has the first end portion 132A and a second end portion 132B. The portion of the wire 132 that is between the first end portion 132A and the second end portion 132B is covered by the substrate 131 and the cover lay 133. The first end portion 132A and the second end portion 132B are portions at which the cover lay 133 is removed and the wire 132 is stripped on the substrate 131.

The portion, which is at the side of the first end portions 132A, of the FPC 130 is nipped in by the second intermediate film 113B and the third intermediate film 113C, between the first glass plate 111 and the second glass plate 112 at the +Y direction side end portion of the laminated glass 110. The first end portions 132A are connected to unillustrated terminals at the +Y direction side end portion of the light adjusting panel 120. As an example, there is a portion at which the FPC 130 and the light adjusting panel 120 overlap between the first glass plate 111 and the second glass plate 112, but an overlapping portion does not have to be provided.

From the portion that is at the first end portions 132A side to the second end portions 132B that are at the −Y direction side of the second glass plate 112, the FPC 130 is bent-over twice along the second side surface 112C, and extends along the third main surface 112A, the second side surface 112C and the fourth main surface 112B.

The portion, which extends along the fourth main surface 112B, of the FPC 130 is affixed to the fourth main surface 112B by double-sided tape 134 as an example. The second end portion 132B side portion of the FPC 130 is positioned at the −Y direction side end portion of the portion, which extends along the fourth main surface 112B, of the FPC 130. Therefore, the portion at the second end portion 132B side of the FPC 130 is affixed to the fourth main surface 112B of the second glass plate 112 by the double-sided tape 134 as an example. Namely, the second end portions 132B are provided at the fourth main surface 112B via the substrate 131 and the double-sided tape 134.

In this way, between the first end portions 132A and the second end portions 132B, the FPC 130 extends along the third main surface 112A, the second side surface 112C and the fourth main surface 112B.

Terminals 141 provided at one ends of the cables 140 are connected to the second end portions 132B by solder 135. Note that the means by which the terminals 141 are connected to the second end portions 132B is not limited to the solder 135, and may be connection by welding or by adhesion by an electrically conductive adhesive, or may be connection by deposition.

The two cables 140 are illustrated in FIG. 2B. As an example, two of the wires 132 of the FPC 130 are provided in correspondence with the two cables 140. The two wires 132 are connected to the positive terminal and the negative terminal of the light adjusting panel 120.

Note that it suffices for the number of the wires 132 to be an appropriate number corresponding to the number of terminals of the thin electric member. Other than the wires 132 for transmitting electric power, the FPC 130 may have the wires 132 that transmit control signals or the like. Note that the shape of the FPC 130 as seen in a plan view may be any shape.

The double-sided tape 134 is, as an example, an arbitrary double-sided tape that can adhere the FPC 130 to the fourth main surface 112B of the second glass plate 112. Further, an adhesive layer or the like may be used instead of the double-sided tape 134. As example, a lead-free solder such as tin-silver solder or tin-silver-copper solder can be used as the solder 135.

The FPC 130, which has the structure in which the wires 132 that are provided at the substrate 131 are covered by the cover lay 133, is extremely thin and has high flexibility. Therefore, the routing at the time of bending-over the FPC 130, from the +Y direction side end portion of the light adjusting panel 120 provided between the first glass plate 111 and the second glass plate 112, along the second side surface 112C and the fourth main surface 112B, and the connecting to the terminals 141 of the cables 140, are extremely easy. Further, the routing being easy relates to an improvement in the electrical reliability of the wires 132. This is because it is difficult for disconnection and damage of the wires 132 to occur. By using the FPC 130, the routing of the wires 132 can be made to be easy, and the electrical reliability can be improved.

### Cables 140

As an example, two of the cables 140 are provided in correspondence with the two wires 132 of the FPC 130. The two cables 140 are respectively connected to the positive terminal and the negative terminal of the light adjusting panel 120 via the two wires 132 of the FPC 130.

Each of the cables 140 has the terminal 141 and the connector 142. The terminal 141 is an example of one end of the cable 140. The connector 142 is an example of the another end of the cable 140. The terminal 141 is connected to the +Y direction side end portion of the cable 140, and the connector 142 is connected to the-Y direction side end portion of the cable 140.

It suffices for the terminals 141 to be terminals that can be connected to the second end portions 132B of the wires 132 of the FPC 130. It suffices for the connectors 142 to be connectors that can be connected to the connector 21 of the wire harness 20 that is at the vehicle body 10 side. Note that, as an example, the terminals 141 and the connectors 142 are respectively fixed to the one ends and the another ends of the cables 140 by caulking, or by connection by solder or an electrically conductive adhesive or the like.

Further, between the terminals 141 and the connectors 142, the two cables 140 are held by the holding member 150. As illustrated in FIG. 2B, the respective cables 140 are held by the holding member 150 in a state of being passed through through-holes 151A that pass through the holding member 150 in the Y direction.

Note that, here, as illustrated in FIG. 2A, as an example, a structure is described in which the +Y direction side end portion of the shielding layer 114 does not overlap the −Y direction side end portion of the FPC 130, but there may be an overlapping portion.

### Holding Member 150

The holding member 150 is described by using FIG. 2C in addition to FIG. 1, FIG. 2A and FIG. 2B. FIG. 2C is a drawing illustrating an example of the structure of the holding member 150. The same XYZ coordinate as in FIG. 2A and FIG. 2B is shown in FIG. 2C.

As an example, as illustrated in FIG. 1, the holding member 150 is provided further toward the inner sides of the laminated glass 110 and the light adjusting panel 120 than the FPC 130 as seen in a plan view, at a portion of one side among the three sides that are the outer edges of the laminated glass 110 and the light adjusting panel 120 that are triangular as seen in a plan view.

As an example, the holding member 150 is provided on the −Z direction side surface of the shielding layer 114, adjacent to the −Y direction side of the −Y direction side end portion of the FPC 130. Therefore, when the vehicle windowpane 100 is viewed from the cabin outer side (the +Z direction side), the holding member 150 is hidden by the shielding layer 114.

Further, the +Y direction side portion (the portion of lengths Y1B and Y1C in FIG. 2C) of the holding member 150 is covered by the frame body 160. The holding member 150 and the shielding layer 114 may be fixed together by double-sided tape or an adhesive. However, because the holding member 150 is held by the frame body 160, the holding member 150 and the shielding layer 114 do not have to be fixed together. It is preferable that the holding member 150 be covered in a state of contacting the frame body 160.

As an example, the holding member 150 can be formed of an elastic resin such as silicone rubber or EPDM (ethylene propylene diene rubber). The holding member 150 has the through-holes 151A through which the cables 140 are passed. Because it is preferable that the regions between the through-holes 151A and the cables 140 are sealable such that they can be sealed, it is preferable to select the material from this standpoint. The reason why being sealable is preferable is in order to suppress the entry of moisture and the like through the through-holes 151A from the exterior toward the interior of the frame body 160. Further, a sealing material may be applied between the through-holes 151A and the cables 140.

The holding member 150 has a base portion 151 and a convex portion 152. As an example, the base portion 151 is a rectangular parallelopiped portion that is provided on the-Z direction surface of the shielding layer 114. The convex portion 152 is the portion of the holding member 150 other than the base portion 151.

The base portion 151 is a rectangular parallelopiped portion of the holding member 150 illustrated in FIG. 2C, and whose width in the X direction is X1, length in the Y direction is Y1, and height in the Z direction is Z1. As illustrated in FIG. 2C, description is given by dividing the base portion 151 into three portions in the Y direction (the portion of length Y1A, the portion of length Y1B and the portion of length Y1C). The portion of length Y1A, the portion of length Y1B and the portion of length Y1C are positioned in that order from the-Y direction side toward the +Y direction side. Hereinafter, there are cases in which the portion of length Y1A, the portion of length Y1B and the portion of length Y1C are called portion Y1A, portion Y1B and portion Y1C.

The −Y direction side end portion (the portion Y1A) of the base portion 151 is exposed at the outer side of the frame body 160. The convex portion 152 is provided at the +X direction side, the −Z direction side and the +X direction side of the +Y direction side end portion (the portion Y1C) of the base portion 151. Of the base portion 151, the portion (the portion Y1B), which is between the −Y direction side end portion (the portion Y1A) that is exposed at the outer side of the frame body 160 and the +Y direction side end portion (the portion Y1C) at which the convex portion 152 is provided, is directly covered by the frame body 160. Further, of the base portion 151, the +Y direction side end portion (the portion Y1C) at which the convex portion 152 is provided is indirectly covered by the frame body 160 via the convex portion 152. Namely, of the base portion 151, the remaining portions (the portions Y1B and Y1C), which are other than the −Y direction side end portion (the portion Y1A) that is exposed at the outer side of the frame body 160, are covered by the frame body 160 directly or indirectly.

At the time of fabricating the frame body 160 by injection molding, of the base portion 151, the portion Y1B that is covered directly by the frame body 160 is the position that the mold directly abuts. Because the mold spans over the portion Y1B as seen in the XZ plane, the portion YIB can be used as an index for positioning the mold.

As illustrated in FIG. 2B and FIG. 2C, the base portion 151 has the two through-holes 151A. The through-holes 151A pass through the base portion 151 in the Y direction. The two cables 140 are passed through the two through-holes 151A. As illustrated in FIG. 2B, the width in the X direction of the base portion 151 is a width of an extent such that the two through-holes 151A that are formed in correspondence with the two cables 140 can fit therewithin.

As illustrated in FIG. 2C, at the +Y direction side end portion (the portion Y1C) of the base portion 151, the convex portion 152 projects out by width X2 at the +X direction side, and by height Z2 at the −Z direction side, and by width X2 at the −X direction side. At the +Y direction side end portion (the portion Y1C) of the base portion 151, the convex portion 152 projects out as seen in the XY plane and as seen in the XZ plane so as to span over the +X direction side, the −Z direction side and the −X direction side of the base portion 151. In other words, the convex portion 152 projects out from the base portion 151 at positions that are at the +Y direction side end portion (the portion Y1C) side of the surfaces of the portion of the base portion 151 (the portions Y1B and Y1C) that is covered by the frame body 160.

Note that it suffices for the convex portion 152 to project out at at least any one side among the +X direction side, the −Z direction side and the −X direction side, at the +Y direction side end portion (the portion Y1C) side of the surfaces of the portion of the base portion 151 (the portions Y1B and Y1C) that is covered by the frame body 160. Further, the convex portion may project out in the +Y direction from the end surface that is parallel to the XZ plane at the +Y direction side of the base portion 151.

Here, the frame body 160 has the inner edge 161A that is at the +Z direction side portion of the laminated glass 110 and the inner edge 161B that is at the −Z direction side portion of the laminated glass 110. In FIG. 2A, as an example, the positions of the inner edge 161A and the inner edge 161B in the Y direction are the same, but the positions of the inner edges 161A and 161B may be different. For example, as seen in a plan view, the inner edge 161A may be positioned further toward the inner side than the inner edge 161B.

Further, the frame body 160 has an inner edge portion 161A1 that is the portion at the +Z direction side of the laminated glass 110, and an inner edge portion 161B1 that is the portion at the −Z direction side of the laminated glass 110. The inner edge portion 161A1 is the end portion that is positioned at the inner edge 161A side that is the portion of the frame body 160 at the +Z direction side of the laminated glass 110. The inner edge portion 161B1 is the end portion that is positioned at the inner edge 161B side that is the portion of the frame body 160 at the −Z direction side of the laminated glass 110.

As seen in a plan view, the holding member 150 is positioned at the inner edge portion 161B1 of the frame body 160. The portions Y1B and Y1C of the base portion 151, and the convex portion 152, of the holding member 150 are covered by the inner edge portion 161B1 of the frame body 160. The cables 140 can be held stably at the boundary between the inner side and the outer side of the frame body 160 due to the holding member 150 being positioned at the inner edge portion 161B1 of the frame body 160 as seen in a plan view.

In the Y direction, the inner edge 161B of the frame body 160 is positioned between the −Y direction side end and the +Y direction side end of the holding member 150, and the convex portion 152 is provided at a position that is offset further toward the +Y direction side than the inner edge 161B. The −Y direction side of the holding member 150 is the side at which the connector 142 is positioned with respect to the holding member 150. The +Y direction side of the holding member 150 is the side at which the terminals 141 are positioned with respect to the holding member 150.

At this holding member 150, at the inner edge portion 161B1 of the frame body 160, the base portion 151 that is at the inner edge 161B side is smaller as seen in the XY plane and the XZ plane than the convex portion 152. Therefore, even though the −Y direction side end portion of the base portion 151 is exposed at the outer side of the frame body 160, the holding member 150 being pulled-out from the frame body 160 can be suppressed. This is because the convex portion 152 latches on the frame body 160. Due to the holding member 150 having the convex portion 152 that projects out from the base portion 151, the holding member 150 being pulled-out from the frame body 160 can be suppressed, and the holding member 150 can be stably fixed at the frame body 160.

Further, the base portion 151 has the through-holes 151A, and the cables 140 are passed through the through-holes 151A. Therefore, the cables 140 can be held stably at the holding member 150 that is fixed by the frame body 160.

Further, even in a case in which the convex portion 152 projects out at at least any one side among the +X direction side, the −Z direction side and the −X direction side at the position of the +Y direction side end portion (the portion Y1C) side of the base portion 151, because the convex portion 152 latches onto the frame body 160, the holding member 150 being pulled-out from the frame body 160 can be suppressed.

Further, the holding member 150 may be a structure that does not have the convex portion 152, if there is no concern that the holding member 150 will be pulled out from the frame body 160 even if the convex portion 152 is not provided.

Note that, here, as an example, a structure in which the holding member 150 is provided on the −Z direction side surface of the shielding layer 114 is described, but the holding member 150 may be provided on the fourth main surface 112B. For example, the holding member 150 may be provided on the fourth main surface 112B in a case in which, as seen in a plan view, the holding member 150 is hidden by the inner edge portion 161A1 that is at the +Z direction side of the laminated glass 110 when the vehicle windowpane 100 is viewed from the cabin outer side, due to, of the frame body 160, the inner edge 161A that is the portion at the +Z direction side of the laminated glass 110 being positioned further toward the inner side (the −Y direction side in FIG. 2A) as seen in a plan view than the inner edge 161B that is the portion at the −Z direction side of the laminated glass 110.

### Frame Body 160

The frame body 160 is a frame-shaped member that is shaped as a triangular annulus and is formed along the triangular outer edge of the laminated glass 110. As illustrated in FIG. 1, the frame body 160 is provided continuously over the periphery of the outer edge of the laminated glass 110, but may be formed at only portions of the outer edge of the laminated glass 110 and may be disconnected therealong. Frame shape here includes structures in which there are disconnected sections therealong.

The frame body 160 is sealed in a state in which the frame body 160 covers and includes the outer edges and the peripheral portions thereof of the first glass plate 111 and the second glass plate 112, the FPC 130, the portions of the cables 140 (including the terminals 141) that are further toward the +Y direction side than the holding member 150, and the portions Y1B and Y1C of the holding member 150. The outer edges of the first glass plate 111 and the second glass plate 112 are the first side surface 111C and the second side surface 112C. The peripheral portion of the outer edge of the first glass plate 111 is the portion of the first main surface 111A that is near the first side surface 111C. The peripheral portion of the outer edge of the second glass plate 112 is the portion of the fourth main surface 112B that is near the second side surface 112C.

Therefore, the frame body 160 is provided so as to contact the portions, which are near to the first side surface 111C and second side surface 112C, of the first main surface 111A and the fourth main surface 112B of the laminated glass 110, and the first side surface 111C and the second side surface 112C.

The frame body 160 is made of a resin for example. The resin that is used for the frame body 160 is not particularly limited provided that it can form a part that is made integral with the laminated glass 110, but is preferably a resin that can be used in injection molding. Resins that can be used in injection molding can be heated and melted, and can be fixed by a cooling processing thereafter.

Forming of the frame body 160 and the vehicle windowpane 100 that includes the frame body 160 is as follows. First, the light adjusting panel 120 is nipped between the first glass plate 111 and the second glass plate 112 via the intermediate film 113, and the FPC 130 that is connected to the light adjusting panel 120 is bent-over along the second side surface 112C and the fourth main surface 112B and is affixed to the fourth main surface 112B by the double-sided tape 134. Next, the holding member 150 is placed on the surface of the shielding layer 114, and the terminals 141 of the cables 140 that have been passed through the through-holes 151A of the holding member 150 are connected to the second end portions 132B by the solder 135. Then, in this state, by placing the laminated glass 110, to which the light adjusting panel 120, the FPC 130, the cables 140 and the holding member 150 have been attached, in a mold and carrying out injection molding, the frame body 160 and the vehicle windowpane 100 that includes the frame body 160 can be formed.

The resin used for the frame body 160 may be a thermoplastic resin. Resins that are used for the frame body 160 include, for example, at least one of thermoplastic elastomer (TPE) materials, polyvinyl chloride (PVC) materials, ethylene propylene diene rubber (EPDM) and thermoplastic vulcanizate (TPV) materials. Thermoplastic elastomer (TPE) materials include olefin-based thermoplastic elastomers (TPO).

In this way, the frame body 160 covers the outer edge of the laminated glass 110 as seen in a plan view, and the FPC 130. Further, the frame body 160 covers the portions Y1B and Y1C of the holding member 150 that holds the cables 140. Therefore, the connected portions of the second end portions 132B of the FPC 130 and the terminals 141 of the cables 140 can be sealed by the frame body 160.

Here, as an approach that is different from that of the present disclosure, for example, a sealing structure can be conceived of in which, in order to seal the connected portions of the second end portions 132B of the FPC 130 and the terminals 141 of the cables 140, a box-shaped member (hereinafter called box member) is readied, and the connected portions are sealed by, at the interior of the box member, connecting the second end portions 132B and the terminals 141, and filling silicone rubber. It suffices for the box member to have a structure such that it can be placed on the surface of the fourth main surface 112B or the shielding layer 114, and to be a size of an extent such that it can accommodate the second end portions 132B and the terminals 141 therein.

In contrast to such a sealing structure, in the vehicle windowpane 100 relating to the embodiment of the present disclosure, because the connected portions of the second end portions 132B and the terminals 141 are sealed by using the frame body 160 that is provided at the outer edge of the laminated glass 110, the number of parts can be reduced, and the structure is simple.

Accordingly, in accordance with the embodiment of the present disclosure, there can be provided the vehicle windowpane 100 that has a simple structure and that includes the frame body 160 that covers the outer edge of the laminated glass 110 at which a thin electric member (e.g., the light adjusting panel 120) is provided between two glass plates (the first glass plate 111 and the second glass plate 112).

Further, in a case in which silicone rubber is filled in as described above, the work for fixing the box member to the laminated glass and the work of filling the resin are required. In contrast, in the vehicle windowpane 100 relating to the embodiment of the present disclosure, because the connected portions of the second end portions 132B and the terminals 141 are sealed in the work of forming the frame body 160 by injection molding, the number of work processes can be reduced, the manufacturing processes can be simplified, and a reduction in costs can be devised.

Further, the frame body 160 is extremely solid because the frame body 160 covers the outer edge, and the peripheral portion thereof, of the laminated glass 110. Because the connected portions of the second end portions 132B and the terminals 141 can be protected by this solid frame body 160, the connected portions of the second end portions 132B and the terminals 141 can be protected over a longer period of time than in a case in which only the connected portions of the second end portions 132B and the terminals 141 are sealed by silicone rubber. Further, due thereto, the electrical reliability of the connected portions of the second end portions 132B and the terminals 141 can be improved.

Further, in a case of using a box member and silicone rubber, space for placement thereof is needed. However, in a case in which the connected portions of the second end portions 132B and the terminals 141 are covered by the frame body 160, there is no need to provide a dedicated space for sealing. Therefore, space saving can be devised.

Note that a decorative member may be provided at the frame body 160. The decorative member is an exterior member or an interior member whose main purpose is to decorate the vehicle window. Further, a control unit that electrically controls the light adjusting panel 120 may be provided at the frame body 160. The control unit may be adhered to the surface of the frame body 160, or may be at least partially embedded.

### First Modified Example

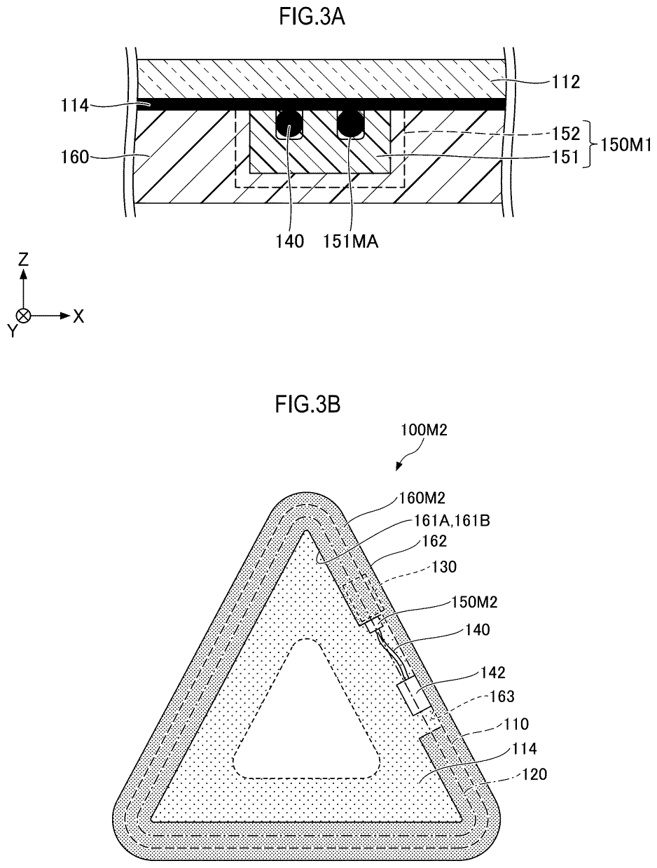

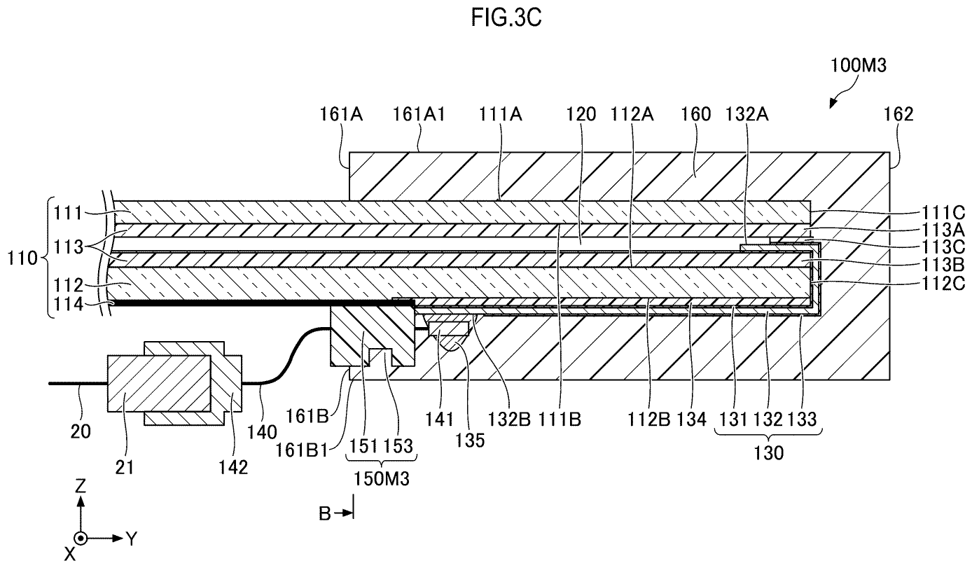

FIG. 3A is a drawing illustrating an example of the structure of holding member 150M1 of a first modified example of the embodiment. FIG. 3A is a drawing illustrating, in the XZ plane, the structure corresponding to FIG. 2B. The holding member 150M1 has a structure in which the through-holes 151A of the base portion 151 of the holding member 150 illustrated in FIG. 2B are changed to groove portions 151MA.

The groove portions 151MA are groove portions that are concave in the −Z direction from the +Z direction side surface of the base portion 151, and are formed so as to extend from the −Y direction side end surface to the +Y direction side end surface of the base portion 151. As an example, two of the groove portions 151MA are formed, and the two cables 140 can be passed therethrough.

The groove portions 151MA are formed in, of the surfaces of the base portion 151, the +Z direction side surface thereof that abuts the shielding layer 114. The base portion 151 abutting the shielding layer 114 is the base portion 151 abutting the fourth main surface 112B via the shielding layer 114.

Note that the width in the X direction and the depth in the Z direction as seen in the XZ plane of the groove portion 151MA are preferably set to be such that no gaps are formed in a state in which the cable 140 is passed through the groove portion 151MA. This is in order to suppress entry of moisture and the like through the groove portion 151MA from the exterior toward the interior of the frame body 160. Further, a sealing material may be applied between the groove portions 151MA and the cables 140.

The connected portions of the second end portions 132B of the FPC 130 and the terminals 141 of the cables 140 may be sealed by using this holding member 150M1 instead of the holding member 150 (refer to FIG. 2A through FIG. 2C), and by covering the holding member 150M1 by the frame body 160 in the same way as the holding member 150. In the same way as the vehicle windowpane 100 of the embodiment, the structure of the vehicle windowpane of the first modified example that includes the holding member 150M1 is simple.

Further, the base portion 151 has the groove portions 151MA, and the cables 140 are passed through the groove portions 151MA. Therefore, the cables 140 can be held stably at the holding member 150M1 that is fixed by the frame body 160.

Further, because the groove portions 151MA are provided at, of the base portion 151, the +Z direction side surface thereof that abuts the shielding layer 114, when the frame body 160 is formed, the cables 140 and the holding member 150M1 are tightly fit to the laminated glass 110 securely. Due thereto, the cables 140 can be held stably by the holding member 150M1, and moisture and the like entering in through the groove portions 151MA from the exterior toward the interior of the frame body 160 can be suppressed.

### Second Modified Example

FIG. 3B is a drawing illustrating an example of the structure of a vehicle windowpane 100M2 of a second modified example of the embodiment. FIG. 3B is a drawing illustrating a structure corresponding to FIG. 1, and illustrates an example of a state in which the vehicle windowpane 100M2 is viewed from the cabin inner side toward the cabin outer side of the vehicle body 10. In the same way as in FIG. 1, the wire harness 20 is omitted from FIG. 3B.

The vehicle windowpane 100M2 differs from the vehicle windowpane 100 with regard to the point that the vehicle windowpane 100M2 includes a holding member 150M2 and a frame body 160M2, instead of the holding member 150 and the frame body 160 of the vehicle windowpane 100 illustrated in FIG. 1.

The position of the holding member 150M2 with respect to the FPC 130 differs from that of the holding member 150 (refer to FIG. 1). The frame body 160M2 has a concave portion 163, at which the inner edges 161A and 161B are concave toward an outer edge 162 side, adjacent to the portion wherein the FPC 130 is positioned as seen in a plan view. The frame body 160M2 does not exist at the portion of the concave portion 163, but the shielding layer 114 is provided, and internal structures are hidden from the cabin outer side.

The holding member 150M2 is provided adjacent to the FPC 130, along one side of the three sides that are the outer edges of the laminated glass 110 and the light adjusting panel 120 that are triangular as seen in a plan view. The holding member 150M2 guides the cables 140 in the direction in which this one side extends. As illustrated in FIG. 3B, the cables 140 and the connectors 142 are positioned at the interior of the concave portion 163 as seen in a plan view.

Because the cables 140 and the connectors 142 are positioned at the interior of the concave portion 163 as seen in a plan view in this way, the cables 140 and the wire harness 20 can be placed at positions nearer to the outer edge of the vehicle windowpane 100M2 that is triangular as seen in a plan view, and space saving can be devised. In other words, the region where the cables 140 and the wire harness 20 are positioned at the central side of the laminated glass 110 can be reduced. Therefore, for example, it is possible to make the width of the shielding layer 114 more narrow and to position the inner edge of the shielding layer 114 further toward the outer side.

### Third Modified Example

FIG. 3C is a drawing illustrating an example of the cross-sectional structure of a vehicle windowpane 100M3 of a third modified example of the embodiment. FIG. 3C is a drawing illustrating, in the YZ plane, the structure corresponding to FIG. 2A. The vehicle windowpane 100M3 of the third modified example of the embodiment has a structure in which the holding member 150 of the vehicle windowpane 100 illustrated in FIG. 2A is replaced with a holding member 150M3. The other structures are similar to the structures of the vehicle windowpane 100 illustrated in FIG. 2A.

The holding member 150M3 has the base portion 151 and a concave portion 153. The base portion 151 of the holding member 150M3 is similar to the base portion 151 of the holding member 150. The holding member 150M3 has a structure in which the convex portion 152, which is provided at the base portion 151 of the holding member 150 illustrated in FIG. 2A, is replaced by the concave portion 153.

The concave portion 153 is a portion that is concave toward the +Z direction side at a portion, which is further toward the −Y direction side than the +Y direction side end, of the −Z direction side surface of the base portion 151. The concave portion 153 may be formed over the entire width in the X direction of the base portion 151, or may be provided at only one portion of the width in the X direction of the base portion 151. Further, the concave portion may be provided at the side surface that is at the +X direction side or the −X direction side of the base portion 151.

In the same way as the holding member 150 illustrated in FIG. 2A, this holding member 150M3 is covered by the frame body 160. When the holding member 150M3 is covered by the frame body 160, the holding member 150M3 is fixed in a state in which a portion of the frame body 160 has entered into the interior of the concave portion 153. Therefore, even though the −Y direction side end portion of the base portion 151 is exposed at the outer side of the frame body 160, the holding member 150M3 being pulled-out from the frame body 160 can be suppressed. This is because the frame body 160 latches on the concave portion 153. Due to the base portion 151 having the concave portion 153, the holding member 150M3 being pulled-out from the frame body 160 can be suppressed, and, in the same way as the holding member 150 illustrated in FIG. 2A, the holding member 150M3 can be stably fixed at the frame body 160.

Further, in the same way as the base portion 151 of the holding member 150 illustrated in FIG. 2A, the base portion 151 of the holding member 150M3 has the through-holes 151A (refer to FIG. 2B), and the cables 140 are passed through the through-holes 151A. Therefore, the cables 140 can be held stably at the holding member 150M3 that is fixed by the frame body 160.

Although an exemplary vehicle windowpane of the present disclosure has been described above, the present disclosure is not limited to the embodiment that has been concretely disclosed, and various modifications and changes thereto are possible without departing from the scope of the Claims.

1. A vehicle windowpane comprising:
a laminated glass provided at an opening portion of a vehicle body and having a first glass plate that has a first main surface, a second main surface and a first side surface, a second glass plate that has a third main surface, a fourth main surface and a second side surface, and an intermediate film provided between the second main surface and the third main surface;
a thin electric member provided between the second main surface and the third main surface;
a wire that, between a first end portion of the wire, which first end portion is connected to the thin electric member between the second main surface and the third main surface, and a second end portion of the wire, which second end portion is provided at the fourth main surface, extends along the third main surface, the second side surface and the fourth main surface;
a frame body made of resin and covering an outer edge of the laminated glass as seen in a plan view, and the wire;
a cable having one end connected to the second end portion of the wire, and another end connected to a wire harness that is at the vehicle body side; and
a holding member provided at the fourth main surface, and covered by the frame body, and holding the cable.

2. The vehicle windowpane of claim 1, wherein the holding member is positioned at an inner edge portion of the frame body as seen in a plan view.

3. The vehicle windowpane of claim 1, wherein the holding member has:
a base portion; and
a convex portion projecting out from the base portion at a position that is further toward the one end side than an end portion that is at the another end side, of a surface of a portion of the base portion that is covered by the frame body.

4. The vehicle windowpane of claim 3, wherein the convex portion is smaller than the base portion.

5. The vehicle windowpane of claim 1, wherein the holding member has:
a base portion; and
a concave portion recessed from the base portion at a position that is further toward the one end side than an end portion that is at the another end side, of a surface of a portion of the base portion that is covered by the frame body.

6. The vehicle windowpane of claim 1, wherein the holding member has a through-hole through which the cable is passed.

7. The vehicle windowpane of claim 1, wherein
the holding member has a groove portion provided in a surface abutting the fourth main surface, and
the cable is passed through the groove portion.

8. The vehicle windowpane of claim 1, wherein the holding member is formed of silicone rubber or EPDM.

9. The vehicle windowpane of claim 1, wherein the frame body has a concave portion at which a portion of an inner edge portion is recessed toward an outer edge side.

10. The vehicle windowpane of claim 1, further comprising a substrate at which the wire is provided, and that extends along the third main surface, the second side surface and the fourth main surface between the first end portion and the second end portion,
wherein the wire and the substrate structure a flexible substrate.

11. The vehicle windowpane of claim 1, wherein the thin electric member is a functional film, an electric heating wire for heating, or an electrically conductive film for heating.

12. The vehicle windowpane of claim 1, wherein the first glass plate is positioned at a cabin outer side of the vehicle body, and the second glass plate is positioned at a cabin inner side of the vehicle body.
